(19) United States
(12) Patent Application Publication
(10) Pub. No.: US 2018/0328625 A1
(43) Pub. Date: Nov. 15, 2018

(54) SYSTEMS AND METHODS FOR SOLAR TRACKING

(71) Applicant: Olivia Schenck, Fishers, IN (US)

(72) Inventor: Olivia Schenck, Fishers, IN (US)

(21) Appl. No.: 15/979,970

(22) Filed: May 15, 2018

Related U.S. Application Data
(60) Provisional application No. 62/603,002, filed on May 15, 2017.

(51) Int. Cl. F24S 50/20; H02S 20/32; F24S 50/40

(52) U.S. Cl. CPC F24S 50/20; F24S 50/40; H02S 20/32

(57) ABSTRACT

Solar tracking systems and methods that do not require external power are provided. The systems have a support surface for attachment to a solar collector device and a pivot member positioned therebeneath. One or more pistons are also positioned beneath the support surface to tilt the support surface around the pivot member when deployed. A reservoir is in fluid communication with each piston such that a pressure increase within the first reservoir automatically deploys the associated pistons, tilts the support surface about the pivot member, and thus positions the solar collector device to face the light source.

### PRIORITY

This application is related to and claims the priority benefit of U.S. Provisional Application Ser. No. 62/603,002 to Schenck, filed May 15, 2017. The content of the aforementioned application is hereby expressly incorporated by reference in its entirety into this disclosure.

### BACKGROUND

Due to concerns over global warming and the limited amount of fossil fuels, renewable energy sources are desired. However, according to the United States Energy Information Agency, only ten percent (10%) of the energy being used in the United States is renewable. One of the most recognized forms of renewable energy is solar energy produced by solar collector devices, which generally utilize photovoltaic and/or photoelectric effects to convert the energy of the sun's radiation into electricity. The performance of such devices is heavily dependent on their orientation relative to the incidence angle of the sunlight.

A perpendicular orientation of the solar collector device's panels (or other surfaces) relative to the incidence angle of sunlight maximizes the solar irradiation of the devices, thus maximizing the total amount of solar energy converted into electrical energy. The incidence angle of sunlight varies in the east-west direction as a function of the time of day and the north-south direction as a function of the time of year. Accordingly, to maximize the amount of energy collected, solar collector devices must be oriented appropriately relative to the sun and repeatedly adjusted.

In view of this, sun-tracking devices (or solar trackers) are used to orient a solar collector device toward the sun and, thus, minimize the angle of incidence. For example, some systems adjust the panel angle of the solar collector device about one or more axes by pivoting and/or tilting the panel(s) with a mechanism that has multiple drive bars and pivot points. This allows the solar collector devices to capture the most sunlight and, thus, increases the amount of energy produced from a fixed amount of installed power generating capacity.

Conventional tracking devices are often mechanically complex, expensive to manufacture, and require a power source for operation. To this end, such conventional devices either comprise a motor (and the associated mechanical linkage) or operate by consuming the energy collected by the solar collection device itself. Tracking devices powered by motors or other generators typically require advanced technology, which further increases the expense of the device such that they are not accessible to most consumers. Utilization of the energy collected by the solar collector device itself is also not ideal as it defeats the purpose of gathering energy and, if completely depleted of energy stores, will inhibit operation altogether. Accordingly, a need remains for cost-effective systems and methods that can effectively adjust the angle of solar collector devices without the need for external power (electrical or otherwise).

### BRIEF SUMMARY

The present disclosure provides systems and methods for solar tracking that do not require external power sources (electrical or otherwise). The inventive concepts underlying the systems and methods hereof correlate to biological systems for plant motion by employing a pneumatic system in a novel approach to solar tracking.

Systems for controlling and/or optimizing the orientation of a solar collector device are provided. Such systems may comprise a support surface comprising a top and a bottom; a pivot member; a first piston; and a first reservoir. The pivot member is coupled with the bottom of the support surface and comprises a multidimensional fulcrum point for tilting movement of the support surface therearound. In at least one embodiment, the pivot member is selected from a group consisting of a half-sphere, a 360° pivot hinge, and a polyaxial ball joint. The first piston comprises an extendable rod and is positioned on a first side of the pivot member beneath the support surface such that extension of the rod (i.e. deployment) applies upward pressure to the support surface and tilts the top of the support surface (i.e. where a solar collector device would be and/or attach) toward a second side of the pivot member. The first reservoir is in fluid communication with the first piston such that a pressure increase within the first reservoir is transmitted to the first piston. In at least one embodiment, the first piston is coupled with the first reservoir by a tub and the first reservoir is positioned on the second side of the pivot member. When the first reservoir (and thus the first piston) is pressurized, the rod of the piston extends.

The system of the present disclosure may alternatively comprise a vertical support member comprising a first end, a second end, and a body extending between the first and second ends. In at least one embodiment, the pivot member is coupled with the first end of the vertical support member and the first piston extends from a portion of the body of the vertical support member. Where a base is used (described below), the second end of the vertical support member is affixed thereto; however, where the system 100 is applied directly to a targeted location without a base, the second end of the vertical support member may be affixed to the targeted location as may be appropriate and/or known in the art (e.g., and without limitation, using screws, nails, adhesive, brackets, etc.).

It will be understood that the system of the present disclosure may comprise any number of pistons. In at least one alternative embodiment, the system further comprises a second piston positioned beneath the support surface such that extension of a rod of the second piston applies upward pressure to the bottom of the support surface and tilts the support surface around the pivot member. Here, the second piston is in fluid communication with a second reservoir such that a pressure increase within the second reservoir is transmitted to the second piston and extends the rod. Furthermore, the first piston is positioned at a first location and the second piston is positioned at a second location, with the first and second locations located on opposite sides of the pivot member.

The first reservoir (and second reservoir, where employed) is configured to house a substance that increases the pressure within the first reservoir in response to a stimulus. In at least one exemplary embodiment, such a stimulus comprises direct light energy and, in still further embodiments, direct sunlight. There, the system is configured such that when a solar cell is coupled with the top of the support surface and the first reservoir positioned on the second side of the pivot member and exposed to the first stimulus (e.g., direct sunlight), the rod of the first piston extends and the solar cell is moved to face the stimulus.

Still further embodiments of the present disclosure comprise one or more reflectors positioned adjacent to or near the reservoir of the system. Additionally or alternatively, the support surface itself may comprise either a bottom portion of a platform coupled with a solar collector device or a bottom surface/portion of a solar collector device.

Additional systems for orienting a solar collector device are also provided. Such systems comprise: a support surface; a pivot member positioned beneath the support surface, the pivot member comprising a multidimensional fulcrum point for tilting movement of the support surface; a first reservoir comprising a substance capable of phase change at a set temperature, the first reservoir positioned on a first side of the pivot member; and a first set of one or more pistons positioned beneath the support surface, each piston of the first set in fluid communication with the first reservoir, comprising an extendable rod, and positioned beneath the support surface such that extension of the rod tilts the support surface around the pivot member toward the first side of the pivot member. There, a phase change of the substance pressurizes each piston of the first set and extends the extendable rod thereof.

Such systems may additionally comprise a second reservoir comprising the substance capable of phase change at a set temperature, the second reservoir positioned on a second side of the pivot member; and a second set of one or more pistons positioned beneath the support surface, each piston of the second set in fluid communication with the second reservoir, comprising an extendable rod, and positioned beneath the support surface such that extension of the rod tilts the support surface around the pivot member toward the second side of the pivot member. As with the first reservoir and set of pistons, a phase change of the substance pressurizes each piston of the second set and extends the extendable rod thereof.

The foregoing systems may also comprise one or more reflectors positioned at or near the first and/or second reservoir(s) to direct light thereto. In at least one embodiment, such reflectors comprise parabolic reflectors positioned around the respective reservoir.

Methods for automatically orienting a solar collector device relative to a light source are also provided. In at least one exemplary embodiment, such a method comprises the steps of: providing a system for controlling the orientation of a solar collector device relative to a light source, the system comprising: a support surface coupled with a solar collector device, a pivot member positioned beneath the support surface, the pivot member comprising a multidimensional fulcrum point for tilting movement of the support surface, a first reservoir comprising a substance capable of phase change at a set temperature, the first reservoir positioned on a first side of the pivot member, and a first set of one or more pistons positioned beneath the support surface, each piston of the first set in fluid communication with the first reservoir, comprising an extendable rod, and positioned beneath the support surface such that extension of the rod tilts the support surface around the pivot member toward the first side of the pivot member; exposing the first reservoir to direct light; extending the extendable rod of each piston of the first set by facilitating a phase change of the substance within the first reservoir in response to the direct light; and applying upward pressure to the support surface to tilt the support surface about the pivot member and position the solar collector device coupled therewith to face the first side and receive the direct light.

The step of extending the extendable rod of each piston of the first set may also further comprises pressurizing the first reservoir and the first set of one or more pistons. Still further, the system may additionally comprise a secondary reservoir in fluid communication with the first reservoir. In such embodiments, the method may also comprise the step of refilling the first reservoir with an additional volume of the substance capable of phase change at a set temperature from the secondary reservoir.

Still further, the system of the present methods may further comprise a second reservoir and a second set of pistons. There, the second reservoir holds the substance capable of phase change at a set temperature and is positioned on a second side of the pivot member. Furthermore, each of the one or more pistons of the second set is in fluid communication with the second reservoir, comprises an extendable rod, and is positioned beneath the support surface such that extension of the rod tilts the support surface around the pivot member toward the second side of the pivot member. In at least one embodiment, such method may additionally comprise the steps of: exposing the second reservoir to direct light; extending the extendable rod of each piston of the second set by facilitating a phase change of the substance within the second reservoir in response to the direct light; and applying upward pressure to the support surface to tilt the support surface about the pivot member and position the solar collector device coupled therewith to face the second side and receive the direct light. In yet another optional step, the method may comprise the step of allowing the substance within the first reservoir to cool and the first reservoir and first set of one or more pistons to depressurize.

### BRIEF DESCRIPTION OF THE DRAWINGS

The present invention will be better understood and features, aspects and advantages other than those set forth above will become apparent in light of the following detailed description. Such detailed description makes reference to the following drawings, wherein:

FIG. 1 shows a side view of at least one exemplary embodiment of a system for automatically controlling or adjusting the orientation of a solar collector device according to the present disclosure;

FIG. 2 shows a side view of at least one alternative embodiment of the system of FIG. 1;

FIG. 3A shows a bottom view of at least one embodiment of a support surface of the system of FIG. 1;

FIG. 3B shows three subfigures of at least one alternative embodiment of a pivot member of FIG. 1 comprising a fixed surface support, with subfigure (1) showing the pivot member in a resting condition, subfigure (2) showing the pivot member tilted laterally to the right, and subfigure (3) showing the pivot member 104 tilted laterally to the left;

FIG. 4 shows a side view of at least one exemplary embodiment of the system according to the present disclosure;

FIG. 5 shows a bottom view of at least one embodiment of piston placement on the support surface relative to the pivot member according to the present disclosure;

FIG. 6 shows tilt angle of the system of FIG. 4 relative to x and y axes;

FIG. 7 shows a schematic representation of at least one alternative embodiment of the system of the present disclosure;

FIG. 8 shows a perspective view of at least one exemplary embodiment of a system for automatically controlling or adjusting the orientation of a solar collector device according to the present disclosure; and

FIG. 9 shows a flow chart representative of a method for automatically orienting the position of a solar collector device relative to a moving light source without the use of external power.

While the present invention is susceptible to various modifications and alternative forms, exemplary embodiments thereof are shown by way of example in the drawings and are herein described in detail. It should be understood, however, that the description of exemplary embodiments is not intended to limit the invention to the particular forms disclosed, but rather the intention is to cover all modifications, equivalents and alternatives falling within the spirit and scope of the invention as defined by the embodiments above and the claims below. Reference should therefore be made to the embodiments above and claims below for interpreting the scope of the invention.

An overview of the features, functions and/or configurations of the components depicted in the various figures will now be presented. It should be appreciated that not all of the features of the components of the figures are necessarily described. Some of these non-discussed features, as well as discussed features, are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. On the contrary, many modifications and other embodiments of the technology described herein will come to mind to one of skill in the art to which the present disclosure pertains having the benefit of the teachings presented in the present descriptions and associated figures. Therefore, it is understood that this disclosure covers any such alternatives, modifications, and equivalents as may be included within the spirit and scope of this application as defined by the specification and appended claims. As previously noted, while this technology may be illustrated and described in one or more preferred embodiments, the compositions, systems, and methods hereof may comprise many different configurations, forms, materials, and accessories.

In the following description, numerous specific details are set forth in order to provide a thorough understanding of the present disclosure. Particular examples may be implemented without some or all of the specific detail and it is to be understood that this disclosure is not limited to particular solar panel systems or applications, which can, of course, vary.

Various techniques and mechanisms of the present disclosure will sometimes describe a connection between two components. Words such as attached, affixed, coupled, connected, and similar terms with their inflectional morphemes are used interchangeably, unless the difference is noted or made otherwise clear from the context. These words and expressions do not necessarily signify direct connections but include connections through mediate components and devices. It should be noted that a connection between two components does not necessarily mean a direct, unimpeded connection, as a variety of other components may reside between the two components of note. Consequently, a connection does not necessarily mean a direct, unimpeded connection unless otherwise noted.

Furthermore, wherever feasible and convenient, like reference numerals are used in the figures and the description to refer to the same or like parts or steps. The drawings are in a simplified form and not to precise scale. The disclosure is presented in this manner merely for explanatory purposes and the principles and embodiments described herein may be applied to devices and/or system components that have dimensions/configurations other than as specifically described. Indeed, it is expressly contemplated that the size and shapes of the system components of the present disclosure may be tailored in furtherance of the desired application thereof.

Unless defined otherwise, all technical and scientific terms have the same meaning as commonly understood by one of skill in the relevant arts. Although any methods and materials similar to or equivalent to those described herein can be used in the practice or testing of the subject of the present application, the preferred methods and materials are described herein. Additionally, as used in this specification and the appended claims, the singular forms “a”, “an” and “the” include plural referents unless the content clearly dictates otherwise. Furthermore, unless specifically stated otherwise, the terms “about” or “near” when used in connection with a range refer to a range of values plus or minus 10% for percentages and plus or minus 1.0 unit for unit values, for example, about 1.0 refers to a range of values from 0.9 to 1.1.

As used herein, the term “solar collector devices” means and includes any device that is designed to convert sunlight into electricity and includes, without limitation, solar panels, parabolic troughs, Fresnel reflectors, the lenses or mirrors of a heliostat, or any other device now known or hereinafter developed that converts the sun's energy into electricity or heat. Likewise, the term “solar cell” refers to a unit for the conversion of solar radiation into electrical energy or heat, whereas the term “solar panel” refers to a module that holds one or more solar cells. Furthermore, the term “solar array” may refer to many solar panels combined together to create one solar collector system. These terms are not intended to be limiting to any particular solar power technology, but instead refer to any number of technologies now known or hereinafter developed that are capable of converting solar radiation into electricity or heat.

In general, the disclosure of the present application provides novel systems and methods for automatically controlling the orientation of a solar collector device without the use of a motor, electricity, or advanced technology. Instead, the inventive systems and methods hereof replicate the biological plant motion of heliotropic plants (i.e. plants that follow the sun) to automatically orient the solar collector devices using pneumatic techniques.

Many plants are known for their directional motion relative to the position of the sun in the sky. Specifically, certain heliotropic plant species orient their leaves and other parts through a process called heliotropism such that they are perpendicular to the sun's rays throughout the day to maximize photosynthesis. Such plants have specialized motor cells within flexible segments of the plant positioned below the portion to be moved (i.e. the flower or leaf). In response to sunlight patterns, these motor cells pump potassium ions into nearby tissues, thereby altering the turgor pressure. The pulvinus segment flexes because the motor cells at the shadow side elongate due to a turgor rise.

Similarly, the inventive systems and methods of the present disclosure utilize pneumatic pressurization resulting from exposure to direct sunlight to automatically position (or orient) a solar collector device relative to the sun. These methods and systems do not require an independent power source to operate because the system's unique configuration automatically orients the solar collector device perpendicular to the sun's rays when a portion of the system is pressurized.

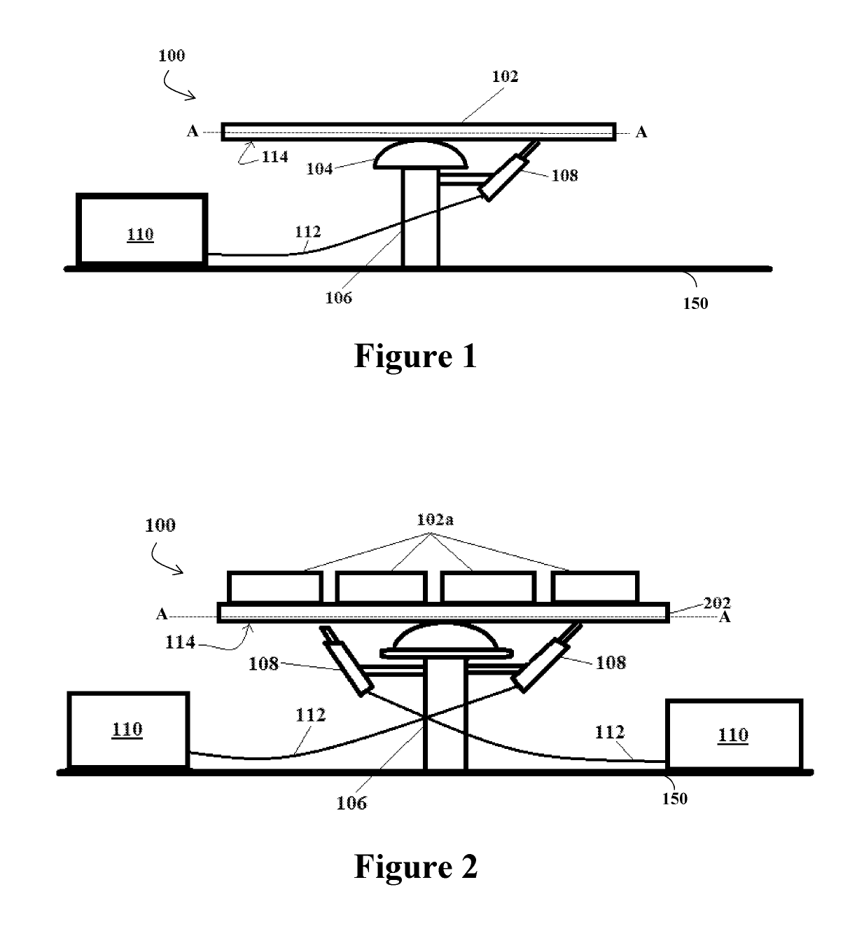

FIG. 1 shows at least one exemplary embodiment of the present disclosure of a system 100 for controlling the orientation of a solar collector device 102. System 100 comprises a pivot member 104 coupled with the underside of a solar collector device 102 such that the solar collector device 102 can tilt in three dimensions. Additionally, the system 100 further comprises a vertical support member 106 coupled with the pivot member 104 and at least one piston 108. Each piston 108 is positioned beneath the solar collector device 102 such that, when the piston rod (see e.g., rod 404 of FIG. 5) of the piston 108 is extended, the solar collector device 102 is tilted around the pivot member 104. Each piston 108 is also in fluid communication with at least one reservoir 110 that, in most cases, is not positioned adjacent to the relative piston 108 (e.g., in FIG. 1, the reservoir 110 is positioned opposite of the piston 108 relative to the pivot member 104). While, in at least one embodiment, the piston 108 is fluidly coupled with the reservoir 110 via plastic, vinyl, or rubber tubing 112, any other coupling means that allows for the transmission of pressure from the reservoir 110 to the tube of the piston 108 may be used.

The solar collector device 102 comprises one or more photovoltaic panels 102a, a solar array, or any other device(s) for collecting solar radiation and converting it into electrical or heat energy, positioned such that the solar cell(s) of the solar collector device 102 face upwards. The solar collector device 102 is positioned over a support surface 114, which may either comprise the underside of the solar collector device 102 itself or, where the panels 102a (or other solar collector device 102) are positioned on or above a platform 202 as shown in FIG. 2, the support surface 114 may comprise the bottom surface of the platform 202. The support surface 114 is coupled with the pivot member 104 positioned on the underside of the solar collector device 102 such that the solar collector device 102 (and platform 202, where employed) can tilt. FIGS. 1 and 2 show the support surface 114 (and thus the platform 202, as applicable, and solar collector device 102) in a level, resting condition where the horizontal axis A-A of the support surface 114 is disposed parallel to the horizontal axis of the base 150 of the system 100. Base 150 may comprise a separate component of the system 100 itself (for example, a base component to provide a steady foundation for the system 100) or it may comprise a roof or like structure to which the system 100 installed.

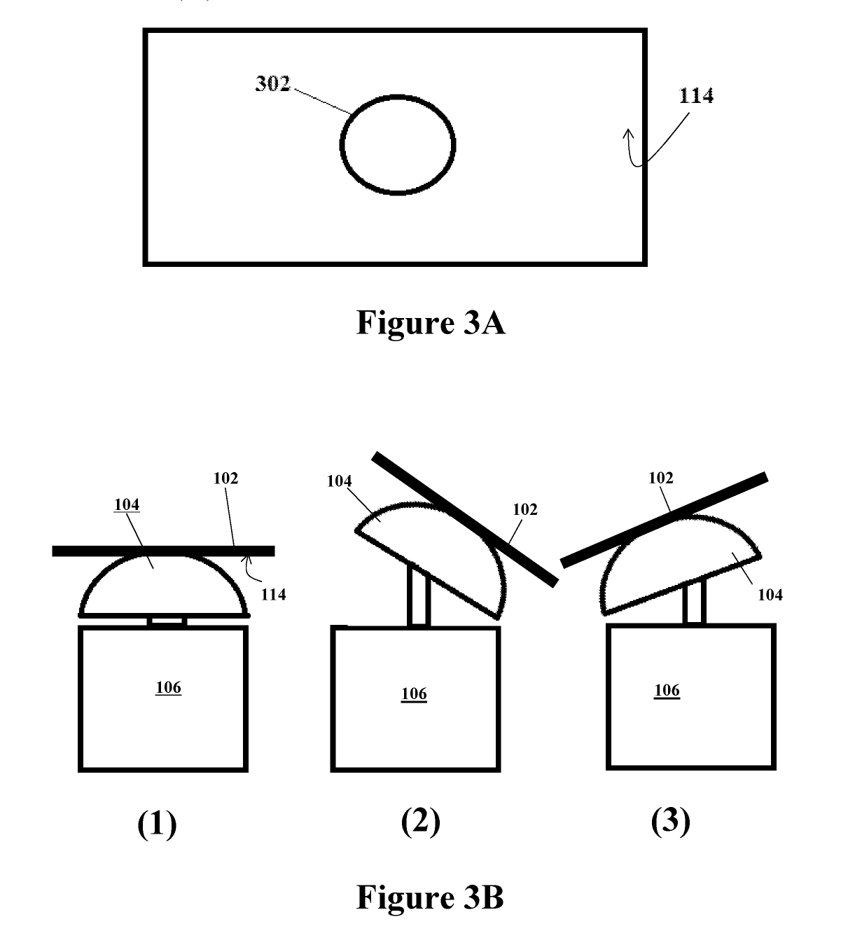

In at least one embodiment, the support surface 114 is flat. Alternatively, the support surface 114 may comprise any shape or texture desired to prevent slippage of the pivot member 104 and/or achieve a target direction/range of movement of the solar collector device 102 when the support surface 114 tilts over and/or around the pivot member 104. For example, in the at least one embodiment shown in FIG. 3A, the plane of the support surface 114 may comprise a circular raised lip 302 and/or a depression (not shown) may be formed in the support surface 114 to receive the pivot member 104. Where a single pivot member 104 is employed as in system 100, such circular raised lip 302 and/or depression may be concentric with the solar collector device 102 and/or platform 202, as appropriate. Such embodiments can be utilized to mate the pivot member 104 to the support surface 114 and, in operation, prevent slippage.

The platform 202 may be made of plastic, metal or natural products, such as wood. In at least one embodiment, the platform 202 is engineered with structural ribs that enable the platform 202 to maintain a high strength to weight ratio as is known in the art. Furthermore, the platform 202 may comprise any shape and dimensions appropriate to support the solar collection device 102 positioned thereon. Inclusion of the platform 202 may or may not be necessary, depending on the configuration of the solar collector device 102.

The pivot member 104 is coupled with the support surface 114 such that the support surface 114 (and thus the solar collector device 102) can tilt with respect thereto. For example, one or more screws, rotational hinge mechanisms, swivel joint hardware, springs, and/or the like may be used to secure the pivot member 104 to the support surface 114, provided the connection ensures that the support surface 114 can be tilted over the pivot member 104 to achieve tilt mobility in any direction. In at least one exemplary embodiment, the pivot member 104 and support surface 114, taken together, may comprise a ball and socket stage configured to provide up to ±60° tilt in any direction of the solar collector device 102 coupled therewith.

In at least one embodiment, the pivot member 104 defines an axis that is oriented perpendicular to the plane of the support surface 114 when in the system 100 is in the resting (balanced) condition. The pivot member 104 may comprise any size, shape, and/or dimensions that allow for the solar collector device 102 to tilt in multiple dimensions and/or around multiple axes therearound. In at least one exemplary embodiment, the pivot member 104 is configured to allow for 360° tilt mobility of the solar collector device 102 around the pivot member 104. FIGS. 1 and 2 illustrate an embodiment of the pivot member 104 comprising a spherical shape; however, it will be appreciated that the pivot member 104 may alternatively comprise a 360° pivot hinge, a polyaxial ball joint, or the like.

In the at least one exemplary embodiment, the pivot member 104 is a spherical or half-spherical shape comprised of a noncompressible material such as steel. Where a noncompressible material is employed, it may also be overlaid with a compressible surface, such as rubber, plastic, or polyurethane foam, to buffer and smooth the solar collector device 102 movement. Alternatively, the pivot member 104 may entirely comprise a somewhat compressible material (such as rubber or the like).

In yet another alternative embodiment, the coupling between the pivot member 104 and the support surface 114 may be fixed, but the pivot member 104 itself may comprise one or more joints or be movable. In such alternative embodiments, both the pivot member 104 and the support surface 114 tilt as a unit but remain stationary with respect to each other. FIG. 3B illustrates at least one example of such a design. Subfigure (1) shows the pivot member 104 in a resting condition relative to a vertical support member 106, subfigure (2) shows the pivot member 104 tilted laterally to the right, and subfigure (3) shows the pivot member 104 tilted laterally to the left. In each of these examples, the pivot member 104 is fixed to the support surface 114/solar collector device 102 such that the two components tilt together, while the lower portion of the pivot member 104 is what rotates/tilts. It will be appreciated that in such embodiments the lower portion of the pivot member 104 may comprise any type of joint and/or hardware that allows for tilted movement (for example, and without limitation, a 360 universal joint, a 360 ratchet joint, or the like).

The pivot member 104 may itself be configured so that it comprises a sufficient height to allow for clearance of the support surface 114/solar collector device 102 when it tilts about the pivot member 104 or, in at least one exemplary embodiment, the pivot member 104 may be coupled with a vertical support 106. As shown in FIGS. 1 and 2, the pivot member 104 is positioned at a top portion of the vertical support 106, which allows for additional clearance when the outermost edges of the support surface 114 tilt. The vertical support 106 may comprise a PVC pipe, a block of wood, a plastic casing, or a metal pipe, for example.

Where a vertical support 106 is employed, the pistons 108 may extend therefrom (either directly or via a connector). Alternatively, if the pivot member 104 provides sufficient clearance itself such that a separate vertical support 106 is not required, the pistons 108 may extend directly from the pivot member 104 (again, either directly or via a connector). The use of a connector will increase the distance X as described below. In at least one embodiment, the tubing 112 may be extend from the reservoir(s) 110 and up through the interior of either the vertical support 106 or pivot member 104 (as applicable) to ultimately communicate with each respective piston 108. It will be appreciated that such embodiments will help protect the tubing 112 from the elements and reduce its wear over time.

As previously noted, the system 100 may comprise one or more pistons 108 that are positioned beneath the solar collector device 102 and support surface 114, and each piston 108 is in fluid communication with at least one reservoir 110. It will be appreciated that while certain embodiments (e.g., FIG. 1) comprise only a single piston 108, any number of pistons 108 may be employed to achieve a desired effect. Likewise, any number of reservoirs 110 may be employed, with either a single piston 108 in fluid communication with its own reservoir 110, or multiple pistons 108 in fluid communication with a single reservoir 110 (for example, a set of pistons 108 positioned on a first side of the pivot member 104). Where a single reservoir 110 is in fluid communication with two or more pistons 108, such pistons 108 will deploy—and thus move the support surface 114—in unison.

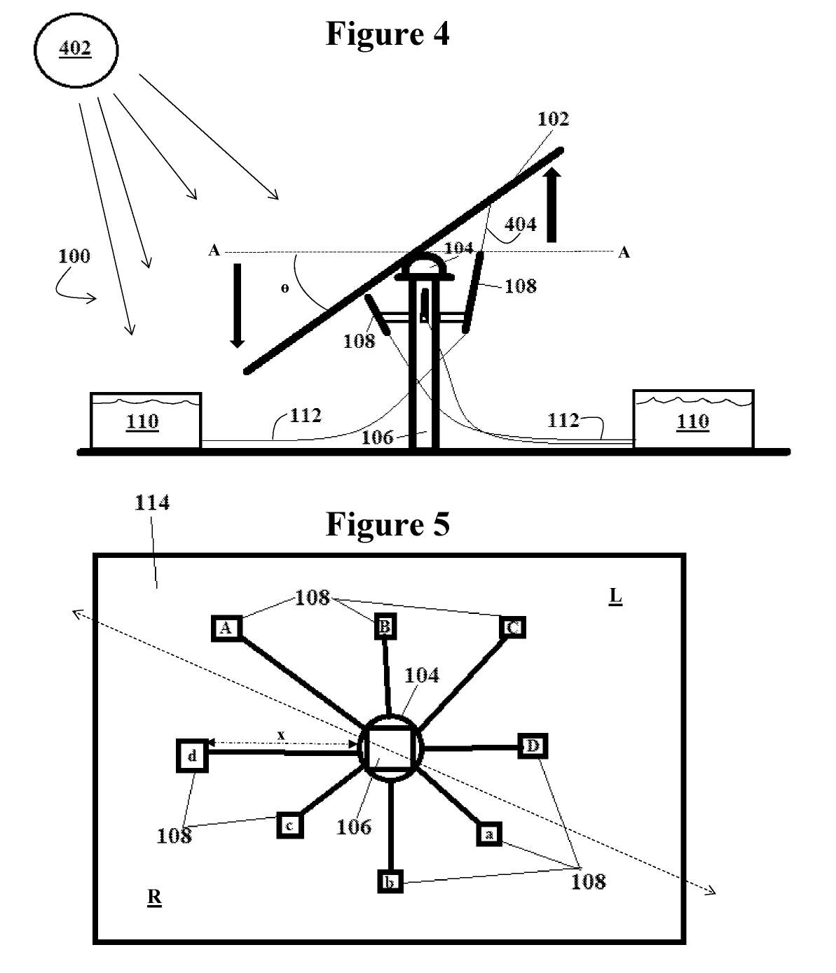

Each piston 108 may comprise any piston or piston-like devices now known in the art or hereinafter developed. In at least one embodiment, each piston 108 comprises a pneumatic cylinder defining a chamber, with a rod seated therein (see rod 404 in FIG. 4). Perhaps more specifically, in at least one exemplary embodiment, one or more pistons 108 comprise a syringe (with the plunger being the rod 404). As is known in the art, the rod 404 can extend from the cylinder or retract therein depending on the pressure within the chamber. Because the chamber of each piston 108 is in fluid communication with one or more reservoirs 110 of the system 100, pressure changes with the respective reservoir(s) 110 will pneumatically drive the rod 404 of the piston 108. Taken together, the piston(s) 108 and the reservoir 110 in fluid communication therewith form a pneumatic system.

FIG. 4 illustrates how, in operation, a pressure increase within the connected reservoir 110, extends the rod 404 of the piston 108, which in turn tilts the support surface 114 (see the arrows in FIG. 4) out of the resting condition (denoted along line A-A). Alternatively, where the pneumatic system comprises a closed system, a decrease in pressure within the connected reservoir 110 and/or chamber of the piston 108 retracts the rod 404 back into the piston 108, thereby allowing the support surface 114 to again pivot over the pivot member 104 and return to the resting condition along axis A-A.

The placement of each piston 108 relative to the pivot member 104 can affect the tilt angle ⊖ and tilt direction of the support surface 114/solar collector device 102 when the piston 108 is deployed. Additionally, the length of the rod 404 of each piston 108 and/or the vertical position of the piston 108 on the vertical support 106 or the pivot member 104 can affect the degree of the tilt angle ⊖ when a piston 108 is deployed. Each of these variables can be modified as desired. For example, a longer rod 404 and/or a higher placement of the piston 180 on the vertical support 106 (i.e. closer to the support surface 114) can achieve a larger tilt angle ⊖. Likewise, modifying the distance X (see FIG. 5) of a piston 108 relative to the pivot member 104 may also affect the degree of the tilt angle ⊖ that can be achieved.

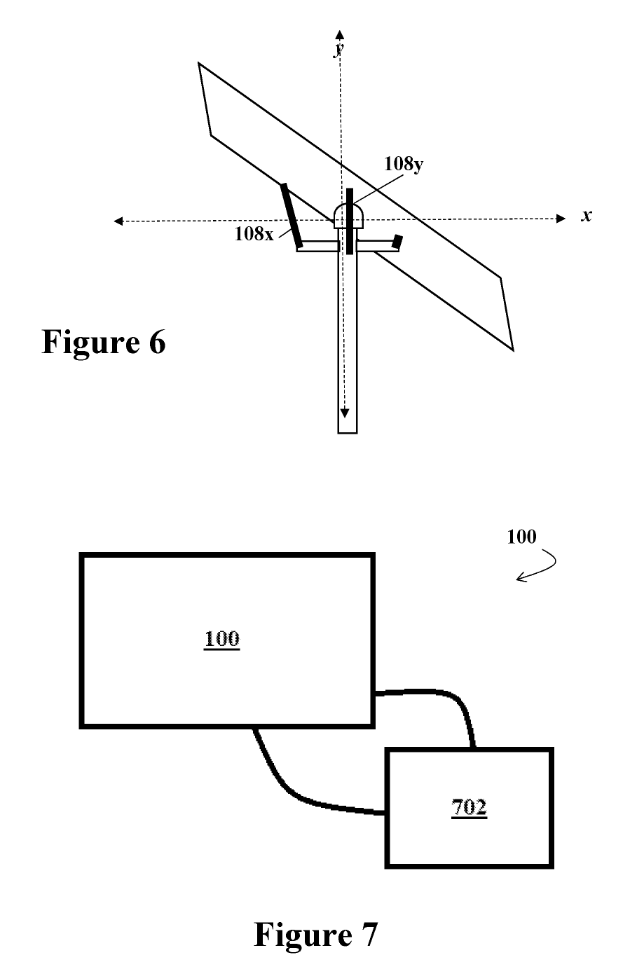

FIG. 5 represents a bottom view of a support surface 114 where the system 100 comprises eight pistons 108. As illustrated in FIG. 5, the distance X between each piston 108 and the pivot member 104/vertical support 106 may vary, as may the individual placement thereof. In this at least one embodiment, each piston 108 has an associated piston 108 positioned across the pivot member 104 (correlative pairs denoted in large/small caps, for example, A-a), which allows for the support surface 114/solar collector device 102 to be tilted/moved in all directions around the pivot member 104. By way of a nonlimiting example, deployment of pistons 108a, 108b, 108c, and/or 108d would cause side R to raise above the horizontal plane of the resting condition, whereas deployment of pistons 108A, 108B, 108C, and/or 108D would cause side L to raise above the horizontal plane of the resting condition. Now referring to FIG. 6, it will be appreciated that the inventive concepts of this disclosure can achieve 360° movement about the pivot member 104. Deploying pistons 108x and 108y, for example, results in tilt along both the horizontal x and vertical y axes (the other remaining pistons 180 remaining undeployed).

Referring back to FIG. 4, the one or more reservoirs 110 of the system 100 each comprise a fixed volume container positioned along the base 150 of the system 100. In at least one embodiment, each reservoir 110 is positioned at or outside of the circumference of the support surface 114 such that it can be hit by direct sunlight from certain angles when the sun 402 is overhead on the side of the system 100 where the reservoir 110 is positioned. Furthermore, for reasons described below, any pistons 108 in fluid communication with the reservoir 110 will be positioned at a location such that the solar collector device 102 will tilt towards the reservoir 110 when such pistons 108 are deployed.

Each reservoir 110 is suitable to contain a volatile substance capable of changing phases from liquid to gas in response to stimulus in the form of sunlight (whether that may be direct sunlight and/or heat resulting from direct sunlight). In at least one embodiment, the reservoir 110 comprises a translucent or semi-translucent jar and the volatile substance therein comprises isopropyl alcohol. While in the examples described herein the reservoir 110 is a glass or plastic jar, it will be appreciated that any material suitable to withstand outdoor conditions, maintain a fixed volume, and that allows direct sunlight to heat any liquid contained therein (whether by conduction or by direct exposure to the light rays) may be employed.

In operation, when direct sunlight hits the glass reservoir 110, the volatile substance therein is heated and converts to a gas. This phase change of the volatile substance from liquid to gas pressurizes the chamber of the reservoir 110 and any piston(s) 108 in fluid connection therewith. Accordingly, when a reservoir 110 is exposed to direct sunlight, the rod(s) 404 of the piston(s) 108 connected thereto extend/deploy in response to the increased pressure and the support surface 114 is tilted accordingly.

As previously described, the pistons 108 may be strategically positioned relative to the support surface 114 such that the resulting tilt moves the attached solar collector device 102 toward the light source (i.e. sun 402) and, in at least one exemplary embodiment, such that the planes of the solar cell(s) are perpendicular to the sun's rays. In this manner, the inventive system 100 hereof automatically and precisely positions the solar collector device 102 to maximize sunlight capture without the use of a motor, generator, or any external energy source. Furthermore, depending on the volatile substance employed, when the reservoir 110 is no longer in direct sunlight such that the overall temperature within the reservoir 110 decreases, the volatile substance converts back to a liquid, thereby reducing the pressure within the pneumatic system, and the rod(s) 404 of the respective piston(s) 108 are withdraw. This, in turn, reduces and/or changes the tilt of the support surface 114 and solar collector device 102 coupled thereto.

Now referring to FIG. 7, in at least one exemplary embodiment, the system 100 may optionally comprise at least one secondary reservoir 702 in fluid communication with one or more of the reservoirs 110. In a closed system, the volume of the volatile substance within the reservoir(s) 110 should not significantly reduce as a result of a phase change; however, from time to time it may be beneficial to refill the reservoir(s) 110 with additional amounts of the volatile substance. Accordingly, one or more secondary reservoirs 702 containing volumes of the volatile substance may be coupled with a reservoir 110 for refill purposes (via tubing or otherwise). The refill amount may be automatically pumped into the reservoir 110 via a pump as is known in the art (e.g., a gravity pump) or manually. Such secondary reservoir(s) 702 may be positioned adjacent to the other components of the system 100 (i.e. on top of a roof or other structure) or may be remote of the other components to facilitate ease of access for refilling purposes. In at least one embodiment, where the majority of the system 100 is placed on the roof of a residence, the secondary reservoir(s) may be positioned in the garage.

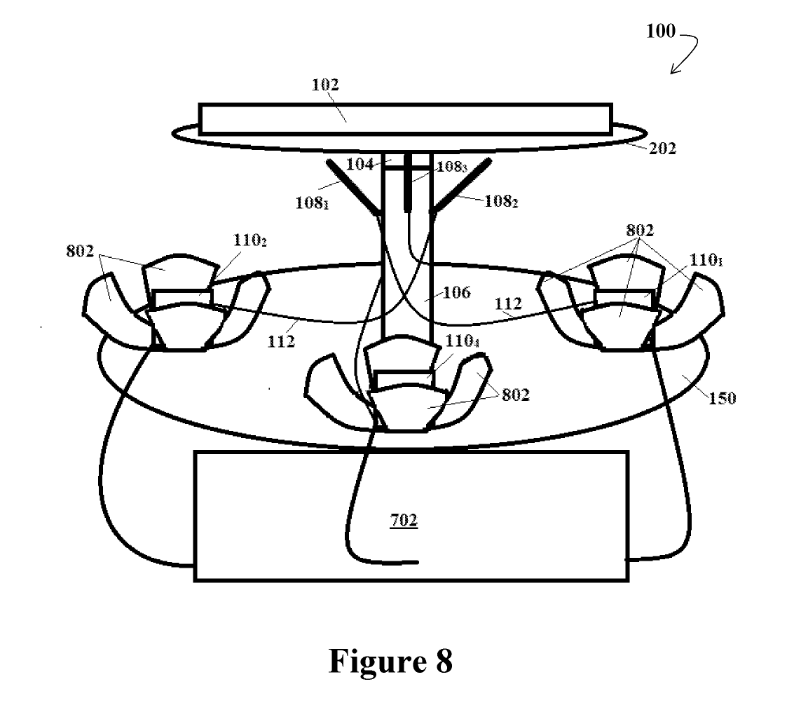

Additionally or alternatively, the system 100 may further comprise one or more reflectors 802 positioned at or near a reservoir 110. The reflectors function to direct and/or concentrate any received sunlight to a particular reservoir 110, thereby reducing “static” and preventing the sunlight from increasing the pressure (i.e. converting the volatile substance(s) to a gas) within multiple reservoirs 100 concurrently. This allows for more precise deployment of the pistons 108 and, thus, positioning of the solar collector device 102. The reflectors 802 may be formed from any material with at least one reflective side including, without limitation, glass, metal, or any other material for reflecting light in a targeted direction. While the reflectors 802 may comprise any shape, in at least one exemplary embodiment, the reflectors 802 are parabolic or petal-shaped and positioned to surround each reservoir 110. FIG. 8 shows a system 100 where each reservoir 110 is surrounded by four parabolic reflectors 802, each shaped and positioned to bounce light waves received on each reflector's 802 surface back to the respective reservoir 110. In this manner, use of the reflectors 802 concentrates light stimuli received at or around the reservoirs 110 and directs the stimuli to the reservoir 110 itself.

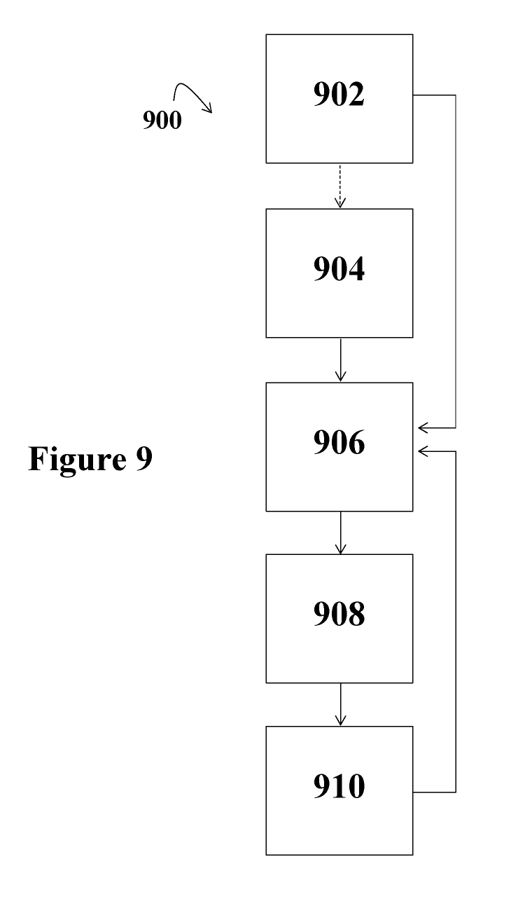

Methods for the automatically positioning a solar collector device so that it is most efficiently orientated with respect to sun rays (i.e. solar tracking) are also provided. In at least one embodiment, method 900 (illustrated in the flow chart of FIG. 9) utilizes system 100 for controlling the orientation of a solar collector device 102 relative to the incidence angle of sunlight. Method 900 uniquely does not require an external source of energy to automatically orient the solar collector device 102, nor does it deplete the energy stored by the system 100 to operate. Furthermore, method 900 does not employ complex mechanical componentry and is thus cost effective to manufacture and operate.

Now referring to FIG. 9, at step 902, the system 100 components are installed on a roof or other location with at least partial sunlight exposure. Where optional base 150 is used with the system 100, the base 150 is affixed to the target location and the remainder of the system 100 is installed thereupon as previously described. In at least one embodiment, the reservoir(s) 110 and vertical support 106 are nailed, screwed, and/or glued to the base 150 and the base 150 is tacked to roof or other target location. Where a secondary reservoir 702 is employed, the secondary reservoir 702 may also be installed on or adjacent to the target location or may be installed in a location that is more accessible for a user. Where employed, the secondary reservoir 702 is coupled with the one or more reservoirs 110 via tubing or the like. As previously noted, the reservoir(s) 110 (and secondary reservoir 702, as applicable) contain a volatile substance such as isopropyl alcohol. In at least one embodiment, the reservoirs 110 may be less than full of the volatile substance such that there is some free space within the chamber; however, this may be modified per user discretion.

Where the goal is to maximize the amount of time the solar collector device 102 is optimally positioned relative to a light source, in its simplest iteration, the reservoir(s) 110 is/are positioned away from the piston(s) 108 to which they are attached. Referring back to FIGS. 4 and 8, reservoir 110₁ is positioned on a first side of the pivot member 104 and the piston 108₁ with which it is in fluid communication is positioned on the opposite (second) side of the pivot member 104. Accordingly, when reservoir 110₁—and thus the first side—is exposed to direct light from a source (see FIG. 4), piston 108₁ is deployed, which pushes the support surface 114 up on the second side and the solar collector device 102 is tilted towards the first side and positioned to face the direct light. Accordingly, a standard configuration of the reservoir(s) 110 relative to their associated piston(s) 108 is to place each reservoir 110 opposite from the piston(s) 108 to which it is attached. However, it will be appreciated that, especially where multiple pistons 108 are in fluid communication with a single reservoir 110, it may be desirable to modify placement of the reservoir 110 with respect to such pistons 108 in order to optimize zenith and/or azimuth tracking. Nevertheless, the underlying concept remains the same: each reservoir 110 and its respective piston(s) 108 are positioned around the pivot member 104 such that when a reservoir 110 is exposed to a direct light source, the piston(s) 108 in fluid communication therewith deploy and tilt the solar collector device 102 toward (and minimize the angle of incidence with) the direct light.

The direction and/or degree of tilt may be further fine-tuned at optional setup step 904. Depending on how the overall system 100 is oriented relative to the cardinal directions and/or the path of the light source, at optional step 904, the position of the piston(s) 108 relative to the solar collector device 102 is modified such that, when the piston(s) 108 are deployed, the desired direction and/or degree of tilt is/are achieved. For example, the position of the piston(s) 108 relative to the solar collector device 102 may be modified by rotating the support surface relative to the pivot member 104 prior to securing the same on setup. Additionally or alternatively, the angle at which a piston 108 extends from the pivot member 104 or vertical support member 106 (where employed) may be manipulated to achieve the desired degree of tilt when the rod 404 thereof is deployed. As with piston 108 placement noted in step 902, the configuration of the piston(s) 108 may also be adjusted at step 904 to optimize zenith and/or azimuth tracking of the sun.

In operation, at step 906, a first side of the system 100 is exposed to direct light. By way of a nonlimiting example, consider reservoir 110₁ of FIG. 8. Due to the configuration and materials of reservoir 110₁ (as well as the closed system between the reservoir 110₁ and piston 108₁) the direct light exposure heats the volatile substance contained within the reservoir 1101. When the volatile substance within the reservoir 110₁ reaches a temperature sufficient to induce a phase change, the reservoir 110₁ and related piston 108₁ are pressurized. The time required to reach this phase change can be decreased using one or more reflectors 802 to direct the light to the reservoir 110₁. Additionally or alternatively, the substance may be selected based on its vaporization point and overall stability.

At step 908, the piston 108₁ in fluid communication with the pressurized reservoir 110₁ deploys and applies upward pressure to support surface 114. This causes the support surface 114 to tilt about the pivot member 104 in a desired direction. As previously noted, the piston(s) 108 are all positioned around the pivot member 104 relative to their respective reservoir(s) 110 such that deployment thereof ultimately causes the solar collector device 102 to face the direct light of the source. Accordingly, at step 908, the solar collector device 102 is moved so that optimizes the direct light received thereon and minimizes the angle of incidence.

Where the light source is the sun, its zenith and azimuth angles will vary throughout the day and/or the seasons, with the azimuth angle being the compass angle of the sun as it moves through the sky from East to West and the zenith angle being the angle of the sun looking up from the ground level or horizon. Due to the system's 100 unique ability to adjust the tilt of the solar collector device 102 around the pivot member 104, not only can method 900 automatically position the solar collector device 102 towards an initial position of the sun, but it can also atomically track its zenith and azimuth positions over time.

When the sun moves so that the initial reservoir 110 is no longer in direct light, at step 910, the volatile substance within such reservoir 110 cools. Notably, due to the placement of the deployed piston(s) 108 relative to the pivot member 104, when the initial reservoir 110 is no longer in direct light, the position of the solar collector device 102 will also no longer be optimized relative to the position of the sun. The cooling of the reservoir 110 again induces a phase change in the volatile substance contained therein, but this time from gas to liquid, which depressurizes the reservoir 110 and related piston(s) 108 (as appropriate, the system 100 may further include one or more release valves along the tubing 112, in the pistons 108, and/or in the reservoir 110 itself to promote this effect or for safety). Upon depressurization, the rod 404 of each deployed piston 108 in fluid communication with the relevant reservoir 110 is withdrawn, thereby allowing the support surface 114 to tilt around the pivot member 104 back towards the resting condition.

However, as the sun changes position across the sky, a second reservoir 110 will eventually receive direct light therefrom. Accordingly, steps 906-910 of the method 900 repeat for the second reservoir 110 and its related piston(s) 108 and the position of the solar collector device 102 is again optimized for maximum sun light exposure. It will be appreciated that this cycle can repeat as many times as needed as the sun (or other light source) moves around the system 100.

While various embodiments of the system and methods of using the same have been described in considerable detail herein, the embodiments are merely offered as non-limiting examples of the disclosure. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A system for optimizing the orientation of a solar collector device, the system comprising:
a support surface comprising a top and a bottom;
a pivot member coupled with the bottom of the support surface, the pivot member comprising a multidimensional fulcrum point for tilting movement of the support surface;
a first piston positioned beneath the support surface on a first side of the pivot member such that extension of a rod of the first piston applies upward pressure to the bottom of the support surface and tilts the support surface around the pivot member; and
a first reservoir in fluid communication with the first piston such that a pressure increase within the first reservoir is transmitted to the first piston and extends the rod.

2. The system of claim 1, wherein the first piston is coupled with the first reservoir by a tube and the first reservoir is positioned on the second side of the pivot member.

3. The system of claim 1, further comprising a vertical support member comprising a first end, a second end, and a body extending between the first and second ends, wherein the pivot member is coupled with the first end of the vertical support member and the first piston extends from a portion of the body of the vertical support member.

4. The system of claim 1, further comprising:
a second piston positioned beneath the support surface such that extension of a rod of the second piston applies upward pressure to the bottom of the support surface and tilts the support surface around the pivot member; and
a second reservoir in fluid communication with the second piston such that a pressure increase within the second reservoir is transmitted to the second piston and extends the rod;
wherein the first piston is positioned at a first location and the second piston is positioned at a second location, with the first and second locations located on opposite sides of the pivot member.

5. The system of claim 1, wherein the first piston is positioned on a first side of the pivot member and the first reservoir is positioned on a second side of the pivot member.

6. The system of claim 1, wherein the first reservoir is configured to house a substance that increases the pressure within the first reservoir in response to a stimulus.

7. The system of claim 6, wherein the stimulus comprises direct light energy.

8. The system of claim 7, the wherein when a solar cell is coupled with the support surface and the first reservoir is positioned on the second side of the pivot member and exposed to the first stimulus, the rod of the first piston is extended and the solar cell is moved to face the stimulus.

9. The system of claim 1, further comprising one or more reflectors positioned adjacent to the first reservoir.

10. The system of claim 1, wherein the support surface comprises either a bottom surface of a platform coupled with a solar collector device or a bottom surface of a solar collector device.

11. The system of claim 1, wherein the pivot member is selected from a group consisting of a half-sphere, a 360° pivot hinge, a ball and socket stage, and a polyaxial ball joint.

12. A system for orienting a solar collector device, the system comprising:
a support surface;
a pivot member positioned beneath the support surface, the pivot member comprising a multidimensional fulcrum point for tilting movement of the support surface;
a first reservoir comprising a substance capable of phase change at a set temperature, the first reservoir positioned on a first side of the pivot member; and
a first set of one or more pistons positioned beneath the support surface, each piston of the first set in fluid communication with the first reservoir, comprising an extendable rod, and positioned beneath the support surface such that extension of the rod tilts the support surface around the pivot member toward the first side of the pivot member;
wherein a phase change of the substance pressurizes each piston of the first set and extends the extendable rod thereof.

13. The system of claim 12, further comprising:
a second reservoir comprising the substance capable of phase change at a set temperature, the second reservoir positioned on a second side of the pivot member; and
a second set of one or more pistons positioned beneath the support surface, each piston of the second set in fluid communication with the second reservoir, comprising an extendable rod, and positioned beneath the support surface such that extension of the rod tilts the support surface around the pivot member toward the second side of the pivot member;
wherein a phase change of the substance pressurizes each piston of the second set and extends the extendable rod thereof.

14. The system of claim 12, further comprising one or more reflectors positioned at or near the first reservoir to direct light thereto.

15. The system of claim 14, wherein the one or more reflectors comprise parabolic reflectors positioned around the first reservoir.

16. A method for automatically orienting a solar collector device relative to a moving light source, the method comprising the steps of:
providing a system for controlling the orientation of a solar collector device relative to a light source, the system comprising:
a support surface coupled with a solar collector device,
a pivot member positioned beneath the support surface, the pivot member comprising a multidimensional fulcrum point for tilting movement of the support surface,
a first reservoir comprising a substance capable of phase change at a set temperature, the first reservoir positioned on a first side of the pivot member, and
a first set of one or more pistons positioned beneath the support surface, each piston of the first set in fluid communication with the first reservoir, comprising an extendable rod, and positioned beneath the support surface such that extension of the rod tilts the support surface around the pivot member toward the first side of the pivot member;
exposing the first reservoir to direct light;
extending the extendable rod of each piston of the first set by facilitating a phase change of the substance within the first reservoir in response to the direct light; and
applying upward pressure to the support surface to tilt the support surface about the pivot member and position the solar collector device coupled therewith to face the first side and receive the direct light.

17. The method of claim 16, wherein the step of extending the extendable rod of each piston of the first set further comprises pressurizing the first reservoir and the first set of one or more pistons.

18. The method of claim 16, wherein the system further comprises a secondary reservoir in fluid communication with the first reservoir and the method further comprises the step of refilling the first reservoir with an additional volume of the substance capable of phase change at a set temperature from the secondary reservoir.

19. The method of claim 16, wherein the system further comprises:
a second reservoir comprising the substance capable of phase change at a set temperature, the second reservoir positioned on a second side of the pivot member, and
a second set of one or more pistons positioned beneath the support surface, each piston of the second set in fluid communication with the second reservoir, comprising an extendable rod, and positioned beneath the support surface such that extension of the rod tilts the support surface around the pivot member toward the second side of the pivot member; and
further comprising the steps of:
exposing the second reservoir to direct light;
extending the extendable rod of each piston of the second set by facilitating a phase change of the substance within the second reservoir in response to the direct light; and
applying upward pressure to the support surface to tilt the support surface about the pivot member and position the solar collector device coupled therewith to face the second side and receive the direct light.

20. The method of claim 19, further comprising the step of allowing the substance within the first reservoir to cool and the first reservoir and first set of one or more pistons to depressurize.
